(19) United States
(12) Patent Application Publication
(10) Pub. No.: US 2009/0321466 A1
(43) Pub. Date: Dec. 31, 2009

(54) Hygienic Door Operating Device

(75) Inventor: Paul Shannon, Templestowe Victoria (AU)

Correspondence Address: THE WEBB LAW FIRM, P.C., 700 KOPPERS BUILDING, 436 SEVENTH AVENUE, PITTSBURGH, PA, 15219, US

(73) Assignee: ANSUTA PTY LTD, Templestowe VIC (AU)

(21) Appl. No.: 12/282,236

(22) PCT Filed: Mar. 17, 2008
(86) PCT No.: PCT/AU2008/000388

§ 371 Date: Dec. 17, 2008

(30) Foreign Application Priority Data
Mar. 15, 2007 (AU) 2007901341

(51) Int. Cl. B65D 85/00; B65H 3/00; E05B 1/00

(52) U.S. Cl. 221/1; 221/102; 221/22; 16/413; 221/12

(57) ABSTRACT

A hygienic door operating device comprising a dispensing means arranged to contain a plurality of gripping handles and adapted to dispense a separate handle to each person operating the door, the gripping handle being adapted to engage a formation secured to the door whereby the door can be operated by manual engagement of the gripping handle and disposal means to transfer the gripping handle to a collection receptacle after use

### FIELD OF THE INVENTION

This invention concerns systems, methods and apparatus for enabling a door to be opened by a person without direct contact with the door components.

### BACKGROUND

It is a matter of common experience that some users of washrooms in public and semi-public places do not have the same hygiene standards as others and may through contact with objects such as taps, door handles and the like contaminate such objects with bacteria- or virus-bearing matter. This can lead to the spread of disease and is therefore generally unacceptable to many washroom users.

Ways have been devised to address this problem, but have various disadvantages and appear not to have been widely adopted. For example, paper doorknob covers may be supplied from a suitable dispenser so that a washroom user can take a cover, place it over a doorknob of the washroom door and then open the door to exit the washroom without having to touch the doorknob. This arrangement suffers from the disadvantage of generating litter and of requiring the use of supplies which are not readily able to be recycled and does not lend itself well to use with D-type pull handles, which are more commonly used in washroom exit door applications.

The present invention addresses the problem of opening a washroom door without having to touch the door or the conventional door handle.

The invention has applications beyond washrooms.

### SUMMARY OF THE INVENTION

Although in this specification the invention is disclosed and described in relation to its application to washrooms, it is believed to have applicability to other areas of activity, for example to “clean room”, laboratory and medical facilities and there is no intention to limit the disclosure specifically to the washroom application.

In a first aspect, the invention provides a hygienic door operating device comprising a dispensing means arranged to contain a plurality of gripping handles and adapted to dispense a separate handle to each person operating the door, the gripping handle being adapted to engage a formation secured to the door whereby the door can be operated by manual engagement of the gripping handle and disposal means to transfer the gripping handle to a collection receptacle after use

The dispensing means is preferably adapted to contain a plurality of gripping devices and to dispense one at a time to the user from a dispensing position.

The dispensing means may comprise means for storing said plurality of gripping devices so that when one gripping device of the plurality of gripping devices is dispensed from a dispensing position another gripping device of the plurality of gripping devices moves automatically into said dispensing position, until all gripping devices of the plurality of gripping devices have been dispensed.

The dispensing means may comprise elongate guide means for holding undispensed gripping devices in an array therealong.

Said gripping devices may be held on and be slideable under gravity along said guide means to said dispensing position at a bottom end of said guide means.

Preferably said dispensing means comprises guard means for preventing access to at least a proportion of the undispensed gripping devices therein excluding the gripping device in the dispensing position. This is to avoid the possibility of undispensed gripping devices being touched before they are dispensed, and possibly contaminated.

The gripping device when dispensed may be adapted for subsequent engagement by the user with the formation on the door. Such engagement may be snap-fitting engagement.

Alternatively, the gripping device when dispensed by the dispensing means may be engaged with the formation on the door. That is, the dispensing means may dispense a gripping device directly onto the formation on the door.

The said formation on the door may comprise an elongate member on which said gripping device is slideable up or down when engaged with the formation. The formation is preferably adapted to be gripped and used as a handle for the door in the event that no gripping device is available or in the event that a user simply elects to grasp the handle directly.

The gripping device may have at least one retaining portion that is retained in and slideable along a slot in said formation when said gripping device is engaged with the formation.

In one embodiment, the dispensing means may be adapted to be:
(a) loaded with a plurality of said gripping devices;
(b) subsequently secured on or adjacent to the door; and
(c) subsequently released and replaced with a further said dispensing devices loaded with gripping devices.

That is, the dispensing means may comprise a cassette, loaded with gripping devices, that is able to be secured as a unit in a desired position and when emptied of gripping devices, replaced with another such cassette loaded with gripping devices.

Preferably, the apparatus further comprises collection means for collecting and retaining said gripping device after said gripping device is discarded by the user.

Said collection means may be adapted to deny access by unauthorized persons to gripping devices collected therein. This reduces the risk of contamination of persons using the door by discarded gripping devices.

The collection means may be adapted and in use positioned on said door to receive gripping devices when let go by a user after use thereof to move the door. That is, with this feature, it is only necessary for a user who has opened the door using a gripping device to let it go, rather than actively put it into the collection means.

Said collection means may comprise an internal space into which gripping devices in engagement with said formation fall under gravity when released by users.

In one embodiment, gripping devices thus released and falling into said internal space engage with elongate guide means therein and are retained on said guide means.

The collection means may be adapted to be:
(a) released from the door with collected gripping devices retained therein; and
(b) subsequently replaced by another collection means on said door in the same position as the released collection means.

This arrangement avoids the need for handling discarded gripping devices at the washroom, and so reduces the potential for harm to maintenance personnel. The collection means may simply be removed as a unit including the discarded gripping devices therein, and taken to for example a central facility equipped to deal with it hygienically.

It is possible for the collection means (or a part thereof) containing collected gripping devices to be adapted to be removed from the door and replaced in an identical position on the door by an identical collection means (or part thereof), with the replacement collection means (or part thereof) comprising an empty said dispensing means (or part thereof). This arrangement can reduce the expense and time required for on-site maintenance. That is, a filled collection means can be removed as a unit for transport to a central treatment facility and the empty dispensing means released from its position and transferred to take up the position and function of the removed collection means.

In a further aspect, the invention provides a method for provision of a hygienic door opening facility at a location, said method comprising the steps of:
providing at least said hygienic door operating device as claimed in any one of the preceding claims;
attaching said device to the door;
providing at least one said gripping handle in said dispensing means;
collecting and removing said at least one gripping handle from said location after use.

The method may include the step of cleaning the or each discarded gripping device and re-using same in the apparatus.

The method may include the step of recycling the discarded gripping devices and manufacturing new gripping devices from the material of such recycled gripping devices.

According to a still further aspect of the invention there is provided a hygienic door operating device adapted to be secured to a face of a door, the device comprising a dispenser adapted to dispense a separate gripping handle to a rotor, the rotor being adapted to locate and hold the gripping handle, the rotor being rotatable from a dispense position in which the gripping handle is located in the rotor within the device to an operative position in which a user can contact the gripping handle to move the door, to a disposal position in which the gripping handle drops from the rotor whereby movement of the rotor facilitates a fresh gripping handle being dispensed.

Note that throughout this specification, the word “comprise” and words derived therefrom such as “comprising” and “comprised”, when used in relation to a set of integers elements or steps are to be taken as indicating that the elements integers or steps are present but not to be taken as precluding the possible presence of other elements integers or steps.

### BRIEF DESCRIPTION OF THE DRAWINGS

Embodiments of the present invention will now be described by way of example only with reference to the accompanying drawing in which:

FIG. 1 is a perspective view of a washroom door with a door operating device in accordance with the first embodiment of the invention fitted to the inner face of the door;

FIG. 2 is a front elevational view of the device;

FIG. 3 is a side elevational view of the device;

FIG. 4 is a rear elevational view of the device;

FIG. 5 is a cross-sectional view taken on the line 5-5 of FIG. 2;

FIG. 6 is a cross-sectional view taken on the line 6-6 of FIG. 2;

FIG. 7 is a cross-sectional view taken on the line 7-7 of FIG. 2;

FIG. 8 is a cross-sectional view taken on the line 8-8 of FIG. 2;

FIG. 9 is a perspective view of a cassette for use with the device shown in FIG. 1;

FIG. 10 is a plan view of the cassette;

FIG. 11 is a perspective view of a dispensing spool which forms part of the device;

FIGS. 12a and 12b are upper and lower perspective views of an indexing rotor;

FIG. 13 is a view of the rotor supporting three gripping handles in the same perspective as FIG. 11;

FIG. 14 is a cut-away perspective view of the upper part of the device with an auxiliary handle shown in dotted profile;

FIG. 15 is a perspective view of the auxiliary handle;

FIG. 16 is a perspective cut-away view of the dispensing spool with adjacent parts shown in dotted profile and illustrating a locking pin and servo motor.

FIG. 17 is a perspective view of a washroom door installation, fitted with a handle, gripper dispenser and gripper receptacle according to a second embodiment of the invention;

FIG. 18 is a side view of the handle, gripper dispenser and receptacle shown in FIG. 17, partly cut away;

FIG. 19 is a cross-sectional view of the dispenser shown in FIG. 18, the section being taken at station AA and the view omitting all detail beyond section BB;

FIG. 20 is a cross-sectional view of the handle shown in FIG. 18, the section being taken at station CC and the view omitting all detail beyond section DD;

FIG. 21 is a cross-sectional view of the receptacle shown in FIG. 18, the section being taken at station FF and the view omitting all detail beyond station GG;

FIG. 22 is a side view of another embodiment of a handle and portions of a gripper dispenser and gripper receptacle, partly cut away;

FIG. 23 is a cross-sectional view of the handle shown in FIG. 22, the section being taken at station HH and all detail beyond station JJ being omitted;

FIG. 24 is a side view of a further embodiment of a handle and portions of a gripper dispenser and gripper receptacle, partly cut away;

FIG. 25 is a side view of a still further embodiment of a handle and portions of a gripper dispenser and gripper receptacle, partly cut away;

FIG. 26 is a perspective view of a mechanism used in the embodiment shown in FIG. 25, with some structural detail omitted for clarity.

### DETAILED DESCRIPTION OF PREFERRED EMBODIMENTS

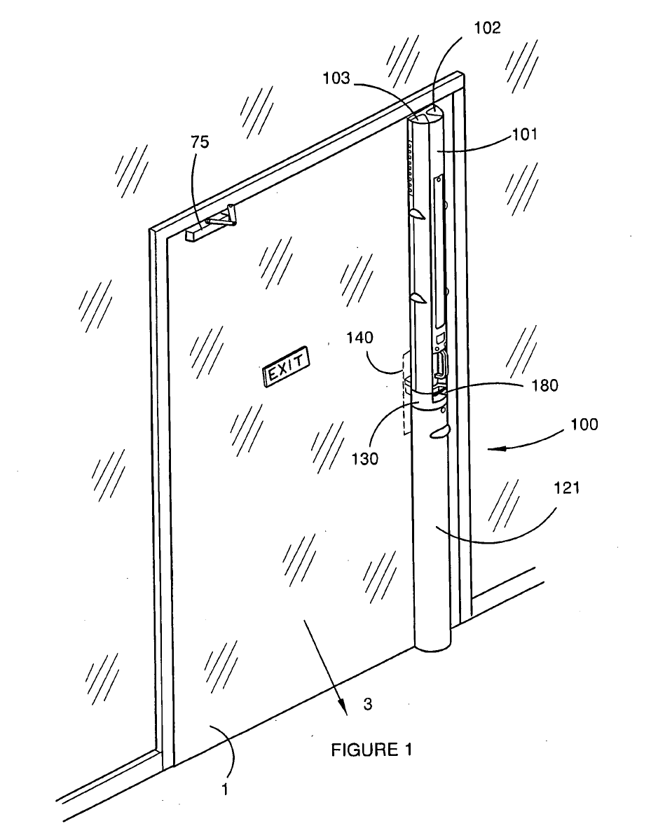

FIG. 1 shows a view of a washroom door 1, seen from the inside of a washroom, i.e. from the side of door 1 that is seen by a person inside the washroom wishing to leave the washroom. The door 1 would usually have a handle for use by persons (not shown) wishing to leave the washroom after using such facilities therein as a toilet (not shown). Washroom doors such as door 1 typically open into the washroom, so that for exit, the handle must be pulled to open door 1, which moves in the direction of arrow 3. Typically a door closer means 75 is provided so that opening the door is all that is needed—a person can simply pass through and allow the door to close subsequently under the action of the door closer 75. A person who has washed his or her hands after using a toilet in the washroom may be reluctant, on hygiene grounds, to touch the handle, knowing that some people do not wash their hands after using toilet facilities, and the present invention addresses this problem.

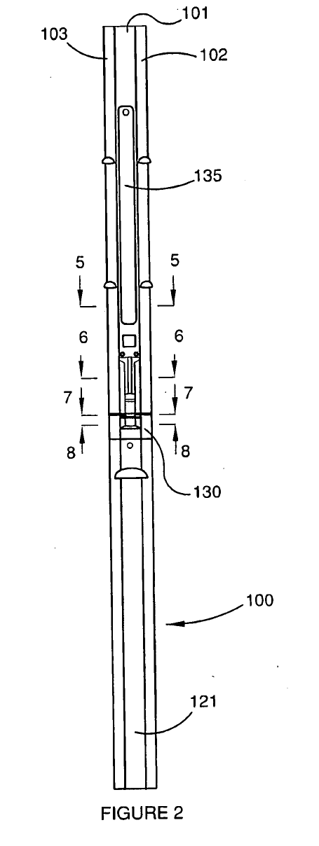

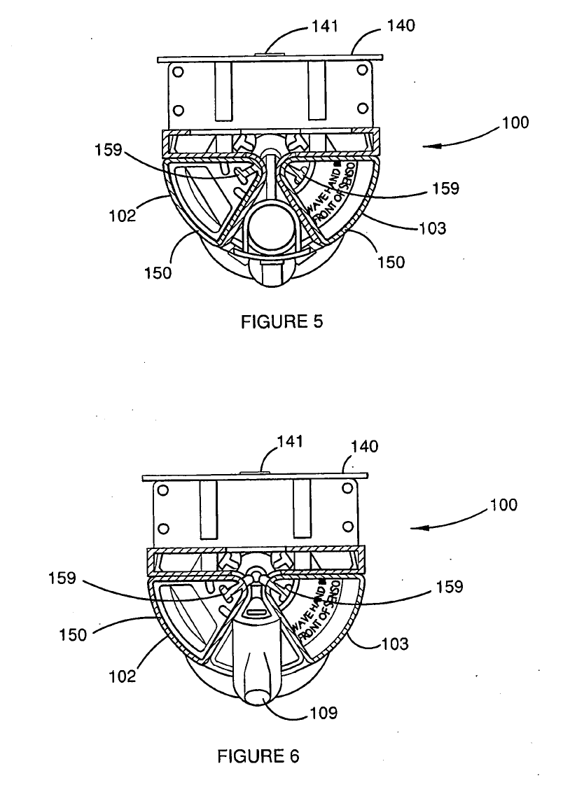

In a first embodiment shown in FIGS. 1 to 16, a door operating device 100 enables a person to open a door 1 without direct contact with the door or the conventional components of the door such as the handle or face plate. As shown in FIGS. 1, 2 and 7 the device 100 essentially comprises dispensing means adapted to dispense a single use gripping handle 150. The gripping handle 150 is positioned so that the user holds the handle 150 to pull the door 1 open against the conventional hydraulic door closer 75. Once the user has completed this action, the gripping handle 150 is transported to a disposal zone. Each time someone approaches the door and activates a proximity sensor 185 by waving a hand in front of the sensor 185, another fresh gripping handle 150 is positioned in an operative position so that the only contact that a person has with the door 1 is via the gripping handle 150.

The device 100 essentially comprises a cassette support 101 for two cassettes 102, 103 containing stacks of gripping handles 150 in the form of tabs made of aluminium. A delivery spool 130 is located under the cassettes 102, 103 and contains an indexing rotor 160 to deliver a gripping handle 150 to an operational zone 180 at the front of the spool 130. A collection bin 121 is located beneath the delivery spool 130. The whole assembly is secured to the inner face of the door 1 on the outer edge of the door so that a pull on the gripping handle 150 has the effect of pulling the assembly and the door 1 open.

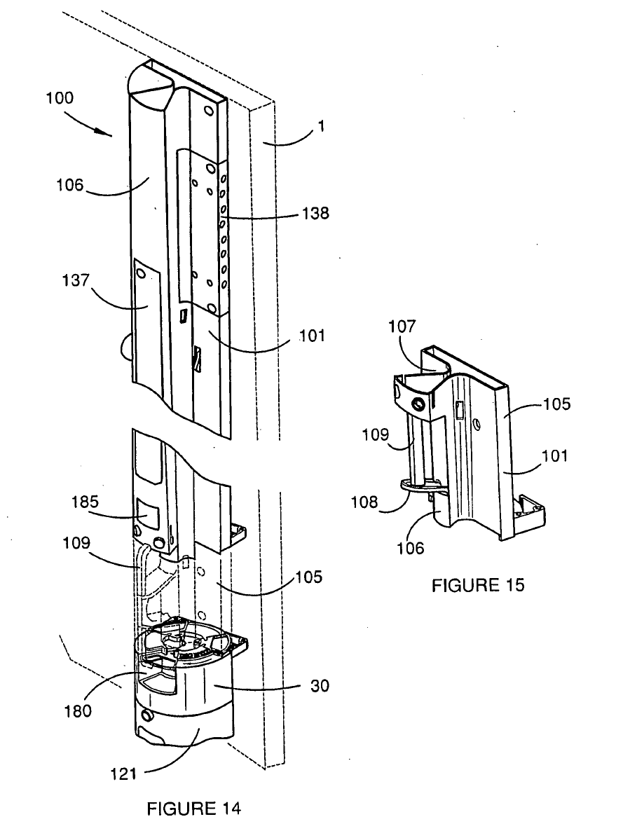

The spool 130 fits directly under the cassette support 101 shown in FIG. 14. The cassette support 101 comprises a substantially rectangular double walled back plate 105 which has a centrally positioned forwardly extending wedge-shaped projection 106, the sides of which define, with the front surface of the back plate 105, an elongate slot 107 into which a cassette 102 of gripping tabs can be clipped into. As shown in FIG. 15, the projecting member 106 defines two such wall structures so that cassettes 102, 103 can be located in a spaced vertical array on either side of the projections 106. The central projection 106 also has a downwardly extending handle 109 which is connected to the projecting member 106 via a base flange 108. The handle 109 operates as an auxiliary handle so that a user can, if necessary, pull or push the door open or closed by gripping the handle 109.

As shown in the assembly views of FIGS. 1 to 4, the collection bin 121 is substantially cylindrical with a flat base 122 and extends down to the base of the door 1 from the underside of the spool 130. As shown in FIG. 1, the overall shape and configuration of the collection bin 121 is similar to the shape and configuration of the cassette support 101 and cassettes 102, 103 which extend up to the top of the door with the dispensing spool 130 being positioned at a convenient hand height for the user.

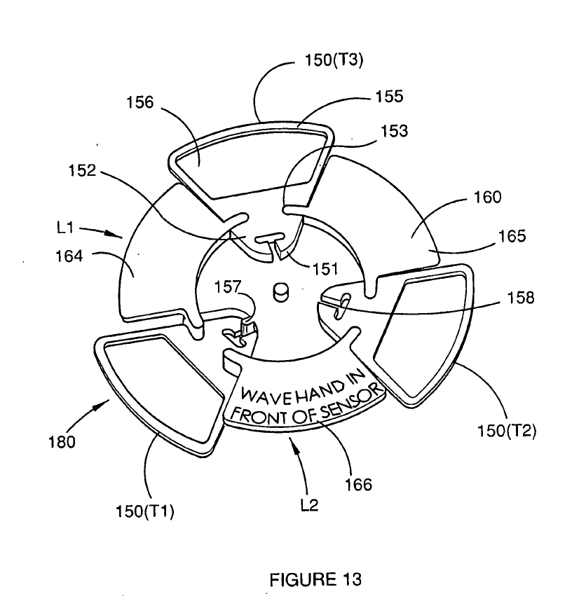

As shown in FIG. 13, each gripping handle 150 is essentially a tab of substantially triangular cross-section with a pointed end 151 which defines a head 152 and a neck 153. The other end defines an enlarged base 155 with a central cut-out 156. The enlarged base 155 defines a portion of the tab which can be grasped by the user's fingers. The indexing rotor 160 locates and supports three such tabs 150. The head 152 and neck 153 co-operate with the rotor 160 to position and locate each tab. By grasping the enlarged base 155 of the tab, the user can simply pull open the door 1.

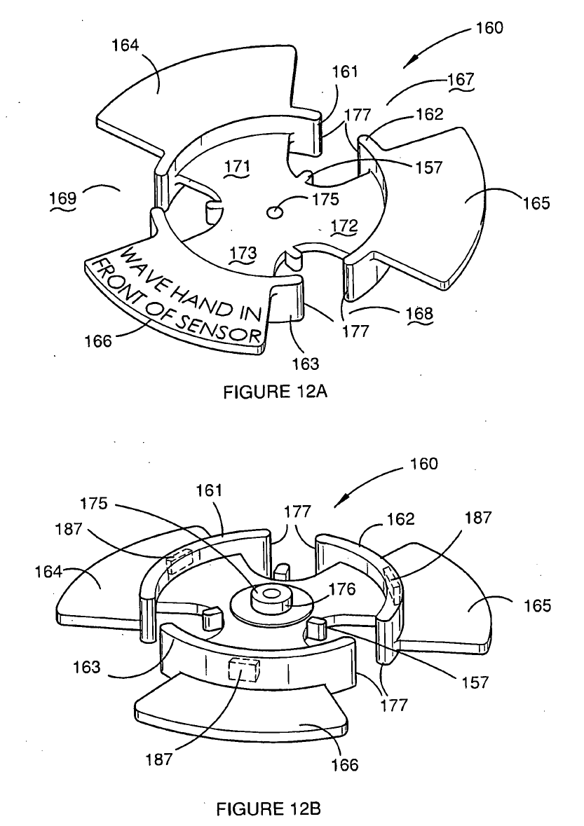

The indexing rotor 160 is shown in detail in FIGS. 12a and 12b and essentially comprises a circular disc which has a central peripheral wall structure defined by three arcuate wall portions 161, 162, 163 each of which has a radially, outwardly extending land 164, 165, 166. The lands define three slots 167, 168, 169 into which a gripping handle (or tab) 150 may be located. The interior of the wall structure defines three equally spaced webs 171, 172, 173 which form a central spigot 175 of the disc. On the underside of the disc, the spigot 175 includes a mounting boss 176 which can be positioned on a shaft (not shown) to facilitate rotation of the disc. Each arcuate wall portion 161, 162, 163 has a projection 177 which extends into the gap between the lands 164, 165, 166 and this projection engages the neck 153 of each tab 150 to locate each tab in the indexing rotor 160.

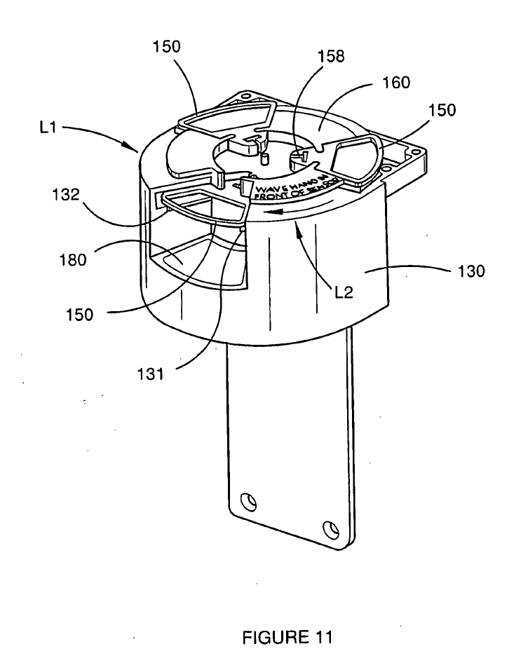

The relationship of the rotor 160 and tabs 150 with the spool 130 is shown in FIG. 11. The arcuate wall portions 161, 162, 163 of the rotor 160 allow the tab 150 to slide vertically down from the upper plane of the rotor. As the rotor turns to the operational zone 180, the tab 150 drops down the wall portions 161, 162, 163 to rest on a pair of spaced ledges 131, 132 projecting from the wall of the spool at a plane lower than the upper plane. This is the operative position shown in FIG. 11 in which the head 152 and the neck 153 of the tab 150 still engages the rotor 160.

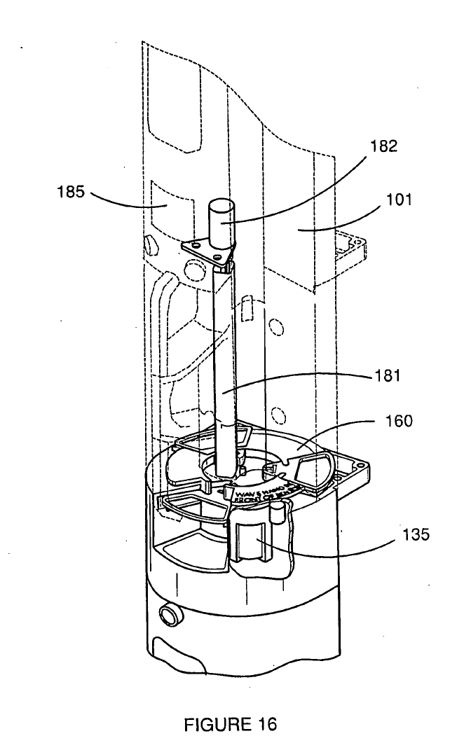

As shown in FIG. 16, the spool 130 houses the indexing rotor 160 and a small electric servo or stepper motor 135 which rotates the disc through six index positions spaced at an included angle of 60°. The front of the spool 130 defines a cut-out that constitutes the operational zone 180. The rotor 160 is positioned underneath the cassette support 101 so that on rotation the slots pass underneath the base of each cassette 102, 103. The rotor 160 is also positioned over the collection bin 121. FIG. 13, which is in the same perspective as FIG. 11, illustrates spaced loading zones L1 and L2, under left and right hand cassettes 103 and 102, on either side of the operational zone 180 at the front of the device at which a tab 150 is exposed for direct finger contact to pull open the door. As the indexing rotor 160 moves past the operational zone 180, the used or soiled gripping tab 150 is dropped by the indexing rotor 160 into the collection bin 121 which is housed underneath the spool 130. The disposal of the used tab 150 can take place on either side of the operational zone 180 depending on the rotational direction of the rotor 160.

Essentially the gripping handles or tabs 150 are fed by gravity down the cassettes 102, 103 to drop into slots 167-169 in the indexing plate 160 to in turn drop to an operative position when in the zone 180. Once the tab has been used to open the door, the tab drops into the collection bin 121.

The head 152 of each tab 150 includes a T-shaped cut-out 158 which is arranged to slide into an appropriately shaped guide 159 at the rear of each cassette 102, 103. Thereby locating the tabs 150 accurately in the cassette. The same T-shaped cut-out 158 provides a three point location of the tabs 150 in the rotor 160 where suitable projections are provided to engage the T-shaped cut-out 158 so that the projection 157, together with the projections 177 in the neck 153 of the tab, provide a three point support ensuring the tab 150 is always accurately aligned.

The indexing procedure of the rotor 160 is illustrated in FIG. 13 which shows a tab T1 positioned in the operational zone 180 ready to be engaged by the user of the door to pull the door open. On the assumption that the rotor is rotating in a clockwise direction, the land 166 is adjacent to exposed tab 150 (T1) is underneath the right hand cassette 102 to engage the rotor 160. The land 165 is then positioned between the tab T2 and the next tab T3 which would also have descended from the left hand cassette 103 which is located over the land 164. As the door returns to the closed position after use of the gripping handle 150, the rotor 160 is indexed through 60°, the first tab T1 is dropped into the collection bin 121 leaving a gap which is then filled by the left hand cassette 103. Once the left hand cassette 103 is empty, the direction of rotation is reversed to pick up gripping tabs from the right hand cassette 102. In the embodiment shown in the drawings, the rotor is indexed to rotate in either direction through 360°. The need to rotate through 360° increases the depth of the device, resulting in the need for the rear of the device to be located in a cut-out in the door. It is however understood that it could be a smaller plate which could oscillate back and forth through 180° picking up gripping handles from either cassette and moving through 60° to present the handle to the operation zone 180. An oscillating smaller plate does away with the need for setting the device into the door.

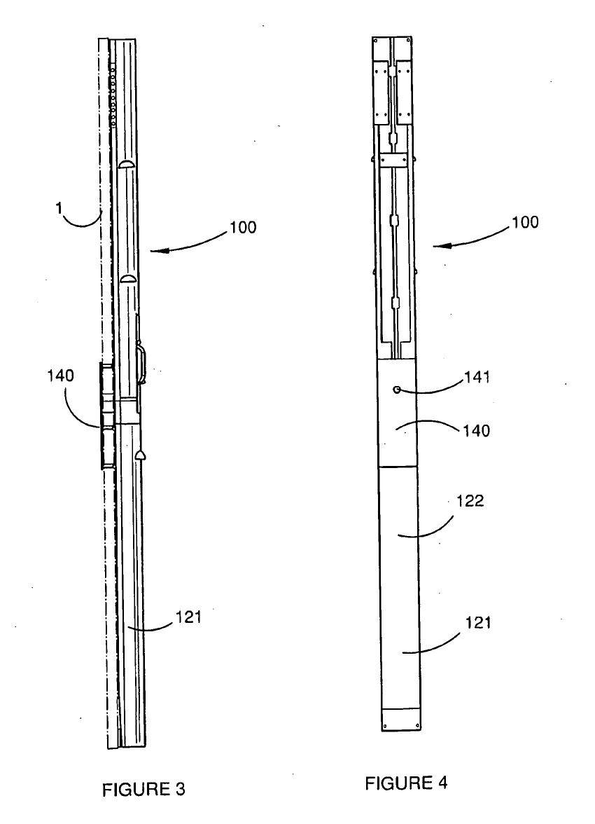

The proximity sensor 185 is positioned at the front of the device 100 so that when a user waves his or her hand at the sensor it activates the servo motor 135 to index the rotor through 60° and present a fresh gripping handle 150 at the operational zone 180. As shown in FIG. 3, a rectangular face place 140 is positioned on the outer face of the door 1 that is on the opposite side to the device 100. The face plate 140 includes an LED 141 that lights up when the proximity sensor is activated thus warning someone approaching the door that someone is about to open the door.

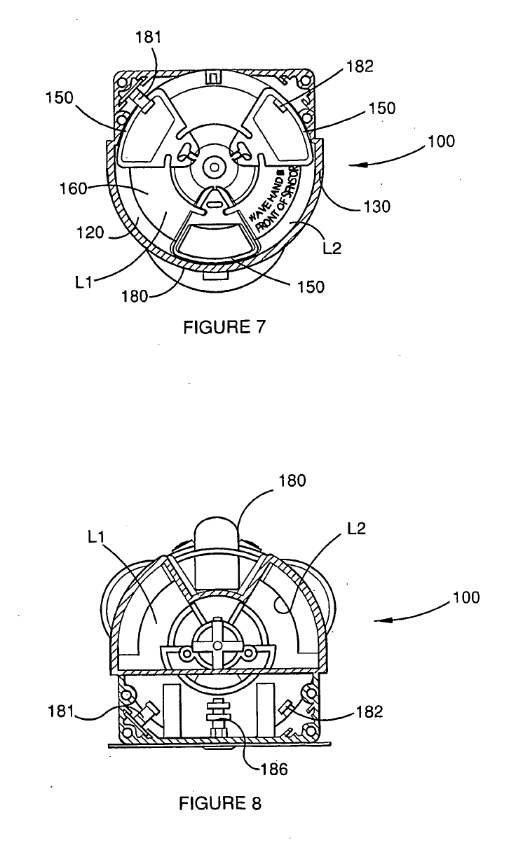

As shown in FIGS. 7 and 8, sensors 181, 182 are positioned behind the two loading zones L1 and L2 to check whether a tab has in fact been dropped into the rotor. In this way, each used gripping handle (tab) is dropped into the collection bin 121 and a fresh tab is supplied to the rotor 160 so that each time a user activates the proximity sensor 185 and the rotor is indexed for rotation, a fresh handle is presented to the user at the operational zone 180. The tabs 150 descend from the cassettes 102, 103 through gravity with the first, or left hand cassette 103, being used before the second, right hand cassette 102 is used.

The underside view shown in FIG. 8 also illustrates a third dead centre recognition sensor 186. This sensor projects radially towards the centre of the rotor 160. As shown in FIG. 12b, suitably located magnets 187 on the interior of the wall structure of the rotor 160 have the effect of causing the rotor 160 to precisely stop in the exact position to ensure alignment with the dispensing cassettes 102, 103 and disposal bin 121. This sensor further reinforces the indexing control of the servo or stepper motor which drives the rotor 160.

As shown in FIG. 16, the device 100 also includes a locking pin 181 which extends vertically above the head of the gripping handle at the operational zone 180. The pin 181 has a head (not shown) which in the locked position engages the handle 150 to prevent the rotor 160 rotating when the handle is engaged by the user. The pin drops through gravity but is lifted up through an electrical solenoid 182 so it is clear of the rotor 160 during the indexing operation.

A safety feature of the apparatus which prevents the possibility of fingers being trapped is provided by two mechanisms to ensure that when the gripping handle 150 is being touched the rotor 160 cannot turn. In the first place, the holding of the tab 150 causes a current build up in the electric motor which, once it passes a certain threshold, causes the motor to stop. Secondly, the tab 150 is made of an electrically conductive material such as aluminium or electrically conductive plastics and a conductive strip is positioned directly underneath the tab 150 so that contact of the tab causes an electrical signal to flow to a switching device which again ensures that the motor does not turn the rotor. This same signal also overrides a timing mechanism so that once the gripping handle 150 is not touched it moves to the dispense position. There is a programmable timing mechanism which waits up to 60 seconds before indexing the rotor in the absence of someone touching the device. The touch signal is provided to speed up the operation so that in a busy environment users do not have to queue to operate the door.

The electric motor is preferably powered by batteries and there is a compartment 137 positioned towards the top of the cassette holder 101 to accommodate C-type batteries which are each of 1.5 volts. The electronics of the circuitry allow the electric motor to run on a range of voltages. It is understood that the device could also be run on mains electricity through a step down transformer. The same power source powers the sensors and a series of service LEDs 138 which are mounted on the top right of the device 100. The service LEDs provide a ready indication when a service call is required such as when one cassette is empty or the collection bin requires emptying. Other routine service issues can also be designated by the LEDs. The device also includes a series of switches which operate to turn off the device should either cassette 102, 103 or the disposal bin 121 be removed. The disposal bin 121 is designed to hold more tabs than are contained in both cassettes so that when the cassettes are replaced there is a simple means of emptying the bin. The cassettes are designed to hold at least 500 gripping handles or tabs in each cassette.

The next page illustrates an operational flow chart based on the following assumptions:
i) The gripping handles 150 from the left hand cassette 103 are in the rear middle position and under right hand cassette 102 position;
ii) The rotor land is in the user operative position;
iii) The locking rotor pin 181 is sitting on top of the rotor 160;
iv) The rotor direction has been set to clockwise;
v) The left hand primary sensor 181 is current; and
vi) The proximity sensor 185 is activated.

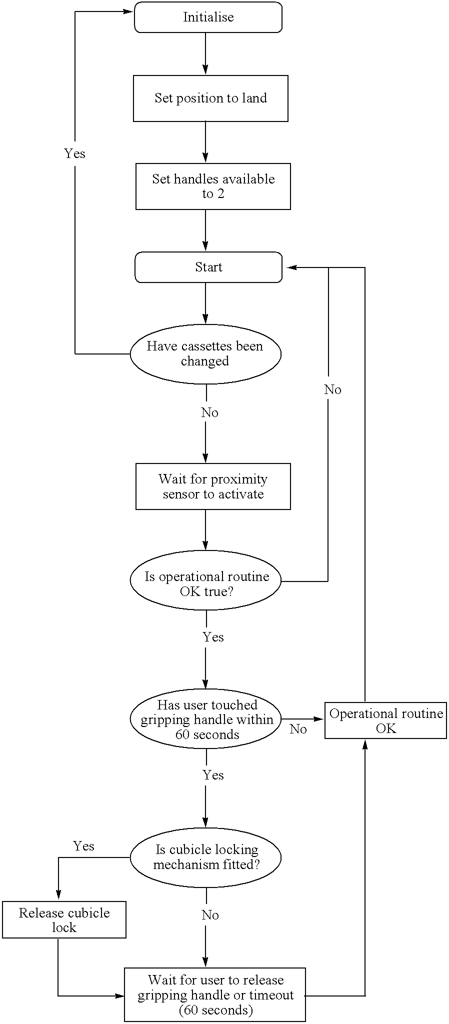

In another embodiment, the device illustrated in FIGS. 1 to 16 can be used as a cubicle lock. A small actuated locking latch is positioned at a position below the spool and is coupled to an actuator which is actuated by switching means it the form of a proximity sensor at a position below the proximity sensor 185. When a user enters the cubicle, the door is pushed open from the outside and then the user calls for a gripping handle by activating the proximity switch 185. When a handle is positioned in the operative zone, the user closes the door and at the same time activates the lower proximity sensor that causes the locking latch to be driven to a locked position in which the door is locked. When the user wishes to open the door, a hand is waved at the lower proximity sensor which unlocks the door and the gripping handle, which is still in the operative position, is used to open the door. When the door is closed, that gripping handle is then transferred to the disposal bin ready for the next use. This embodiment would require modification to the timing to ensure that the gripping handle remains in the operative zone whilst the person is within the cubicle.

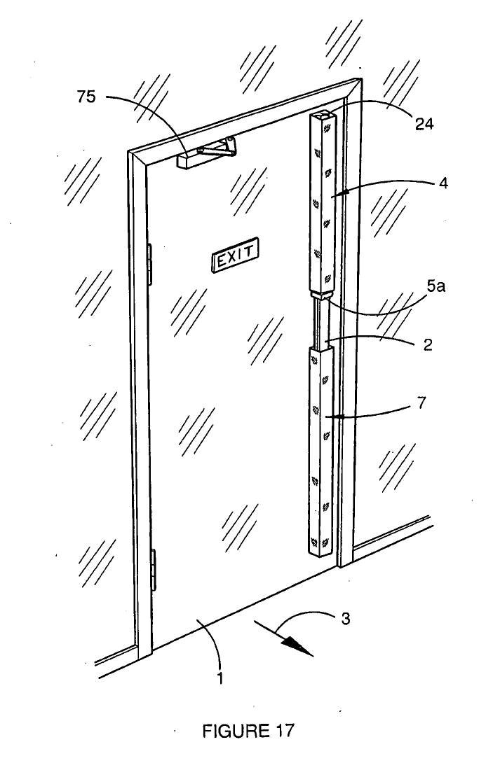

In a second embodiment shown in FIGS. 17 to 21, a dispenser 4 is secured to a door 1 above handle 2 from which a person wishing not to touch handle 2 can obtain a clean, hand-held gripper 5 by means of which the person may grip the handle 2 and pull door 1 open without having actually to contact handle 2. A gripper 5a is visible at the lower end 6 of dispenser 4 and can be dispensed to the person by simply being pulled away from door 1.

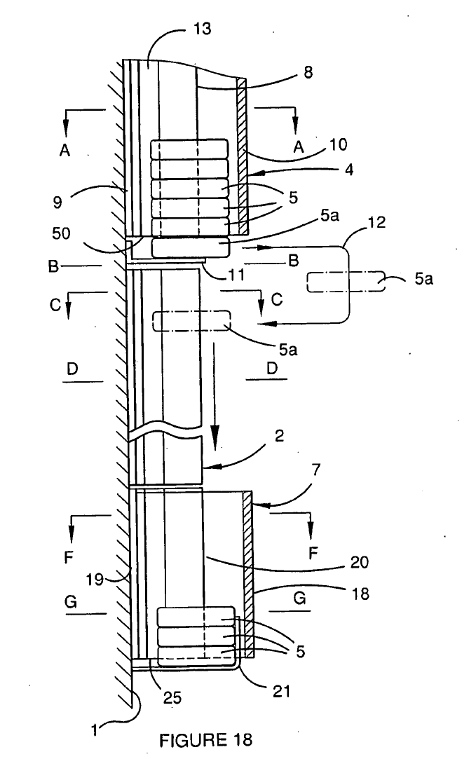

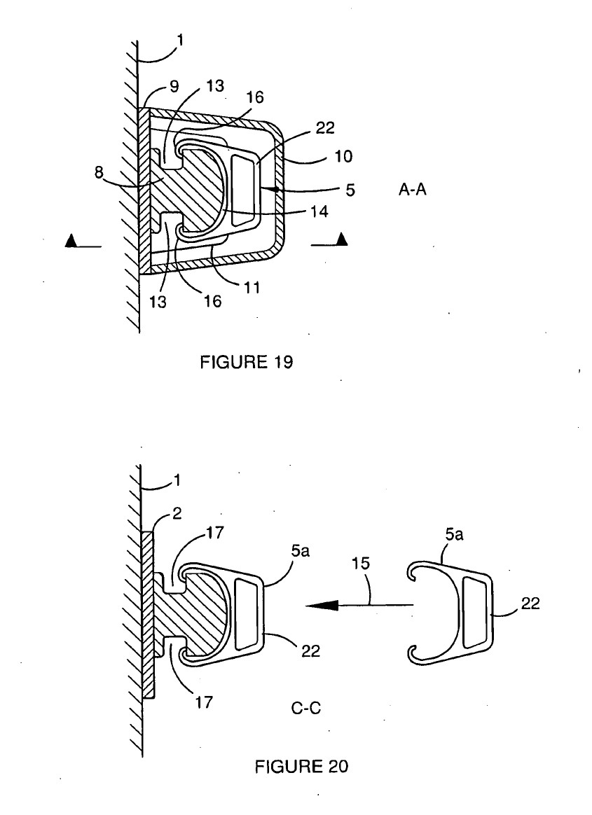

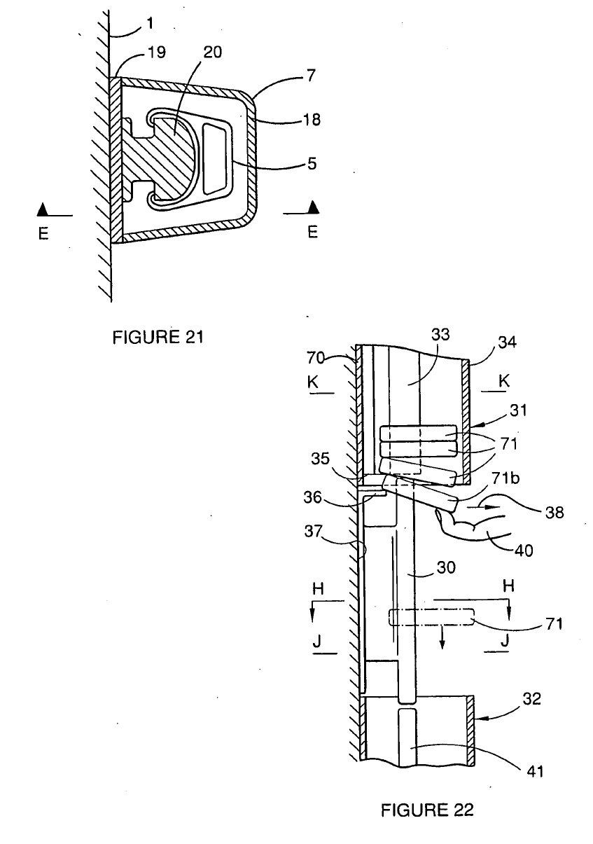

FIG. 18 shows a side view, partially sectioned, of handle 2, the lower end of dispenser 4, and portions of a receptacle 7 that receives discarded grippers 5. FIGS. 19 and 20 show cross-sectional views of the dispenser 4 and handle 2 respectively. Station EE on FIGS. 19 and 21 is the station at which the sectioning is taken in FIG. 18.

Dispenser 4 comprises a vertical guide rail 8 on which a supply of clean grippers 5 is held and able to slide downward under the action of gravity, a base plate 9 and a cover 10. Cover 10 prevents access to grippers 5 on guide rail 8 except for the lowermost gripper 5a. A stop plate 11 extends outwardly from base plate 9 and serves to stop lowermost gripper 5a from sliding downwardly off guide rail 8. A lower end 50 of guide rail 8 ends far enough above plate 11 that lowermost gripper sa can be dispensed to a person who simply pulls it outwardly away from door 1, as shown by arrow 12 in FIG. 18. The remaining grippers 5 then fall downward along guide rail 8, the lowermost one of them then being positioned against plate 11 for dispensing. In FIG. 18, gripper 5a is shown in full lines in the position it occupies before being dispensed and in chain-dotted lines in its position after being dispensed and when secured to handle 2 as described below.

As can be seen in FIG. 19, guide rail 8 has side recesses 13 into which are received hook-like projections 16 of gripper 5, so that grippers 5 are held on guide rail 8. Between the remainder of gripper 5 and guide rail 8 is a clearance space 14, giving enough clearance so that grippers 5 can slide freely lengthwise on guide rail 8.

As shown in FIG. 20, handle 2 has the same cross-sectional shape as guide rail 8. After obtaining a clean gripper 5a from dispenser 4, a person can push that gripper 5a toward handle 2, as shown by arrow 15 in FIG. 20 (and the lower part of arrow 12 in FIG. 18) so as to snap-fittingly engage gripper 5a on handle 2 in the same way as on guide rail 8. Gripper 5a is formed from a material that is resilient and flexible (e.g. by injection moulding in a suitable thermoplastic material) so that projections 16 are pushed outward as gripper 5a is pushed into place over handle 2 and then rebound inward to enter and be retained in side recesses 17 of handle 2. By pulling on cross-member 22 of gripper 5a the person can open door 1 without having to touch handle 2. Once this is done, the person can simply release gripper 5a, allowing it to slide downwardly along handle 2.

Receptacle 7 has a cross section, shown in FIG. 21, that is identical to that of dispenser 4 as shown in FIG. 19, over most of its length. Receptacle 7 has a cover 18, a base plate 19 and a guide rail 20, the guide rail 20 having the same cross-sectional shape as guide rail 8 and handle 2. Guide rail 20 is positioned directly below handle 2, so that when a person releases gripper 5a, gripper 5a simply slides down handle 2 (as shown by arrow 23 in FIG. 18) and onto guide rail 20 of receptacle 7. As shown in FIG. 18, discarded grippers 5 slide down guide rail 20 and accumulate thereon at its lower end 25. A hook 21 prevents grippers 5 falling off the lower end 25 of guide rail 20. Note that cover 18 is optional—guide rail 20 could simply be left exposed.

The cross-sectional shape of handle 2 is such that a person not wishing to use a gripper 5 as described above can still open door 1 by gripping device 2 directly.

For ongoing use of the system shown in FIGS. 16 to 21, without having to revert to direct contact between users and handle 2, it is of course necessary that dispenser 4 be provided from time to time with a fresh supply of clean grippers 5 and that the grippers 5 in receptacle 7 be removed for cleaning, disposal or recycling.

One way to do this is to feed a new supply of clean grippers 5 onto guide rail 8 from its upper end 24 (FIG. 16) and to temporarily remove hook 21, to allow used grippers 5 to be removed from the lower end 25 of guide rail 20 of receptacle 7. This approach allows dispenser 4 and receptacle 5, as well as handle 2, to be fixed permanently to door 1.

However, in another embodiment of the invention, dispenser 4 and receptacle 7 can be made removable from door 1. Then, to provide a new supply of grippers 5, an empty dispenser 4 can be removed from door 1 and a new dispenser 4, already filled with a supply of clean grippers 5 simply placed on door 1 in its stead. Similarly, a receptacle 7 filled with used grippers 5 can be removed from door 1 as a unit and replaced with a new receptacle 7 that is empty. The actual emptying of removed receptacle 7 and refilling of removed dispenser 4 could then be done at a suitable centralized facility away from the point of their actual use.

It will be noted in FIG. 18 that hook 21 and stop plate 11 are shown as secured to the door 1. This being so dispenser 4 and receptacle 7 can be made identical (including as to gripper 5 capacity), so that a further possibility is to:
(a) remove a full receptacle 7 for return to, and emptying at, a centralized facility;
(b) transfer empty dispenser 4 from its position above handle 2 to the position of the removed receptacle 7; and
(c) lace a new dispenser 4, filled at the centralized facility in position on door 1.

This variation reduces the amount of parts handling and transport required of personnel servicing washrooms.

Dispensers 4 filled with clean grippers 5 may be wrapped (e.g. in paper, cellophane or plastics film) until installation to ensure that their cleanliness is not compromised prior to installation.

Although not shown, door 1 and/or dispensers 4 and receptacles 7 may be provided with suitable locking means (e.g. key-operated) to prevent unauthorized removal of dispensers 4 or receptacles 7 from door 1.

Multiple dispensers 4 may be mounted on door 1 if required, for example to provide a larger supply of grippers 5. However, it is not essential to mount dispenser 4 on door 1 at all. Instead, one or more dispensers of grippers 5 (such as dispenser 4 or another suitable type) may be mounted on a wall beside the door or outside the washroom or in any other suitable and convenient location. This may be done for example in exceptionally busy washrooms where not enough grippers 5 could be contained in a single dispenser such as dispenser 4.

Similarly, it is possible to mount more than one receptacle such as receptacle 7 on door 1, where more grippers 5 need to be collected. Each may be provided with its own handle 2.

Another possibility is to provide grippers 5 from a coin- or token-operated vending machine. Vending machine technologies for automatically vending a wide range of items are well known and need not be further described here. A further and related possibility is an adaptation of the system (known in the art of providing supermarket trolleys) whereby a coin must be deposited to obtain the item required (in this case a fresh gripper 5), and a coin is returned when that gripper is returned. This option would require modification of both the dispensing and gripper-receiving parts of the system.

FIG. 22 shows another embodiment of the invention. FIG. 22 is directly comparable in viewpoint with FIG. 18, showing a handle 30, a dispenser 31 for grippers 71 (the same as grippers 5), and a receptacle 32 for discarded grippers 71. Dispenser 31, handle 30 and receptacle 32 are arranged one above the other on a door 37 in the same way as items 4, 2 and 7 are arranged on door 1, as shown in FIG. 16. Dispenser 31 comprises a guide rail 33 the same as guide rail 8, a cover 34 the same as cover 10 and a base plate 70 the same as base plate 9 and its cross section at station KK (FIG. 22) is identical to the cross-section of dispenser 4 shown in FIG. 19.

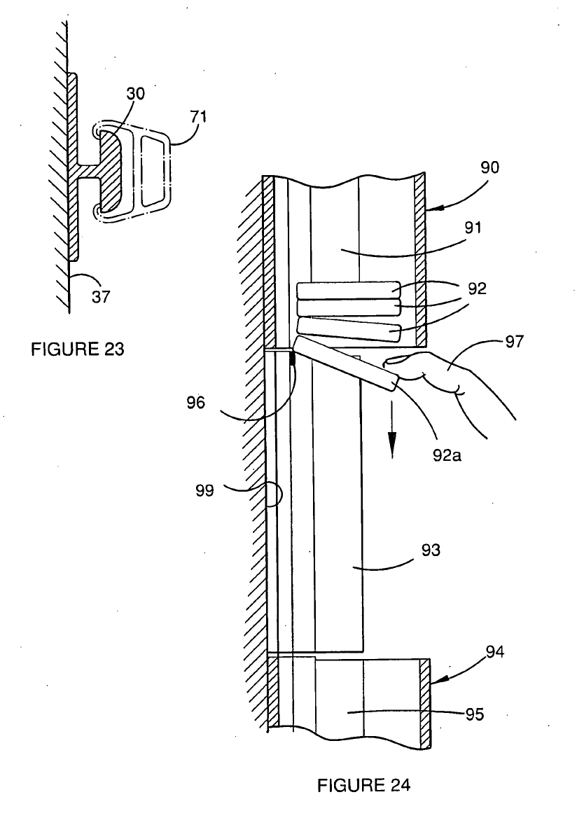

Grippers 71 in dispenser 31 accumulate at the bottom end 35 of guide rail 33, with a lowermost one 71b of grippers 71 abutting a plate 36 that extends outward from door 37. A person can use handle 30 to open door 37 by directly gripping device 30 if required, but to avoid such contact, may instead pull gripper 71b outwardly with a finger 40 as shown by arrow 38 until gripper 71b clears plate 36. However, outward movement of gripper 71b creases when gripper 71b becomes captive on handle 30, in the manner shown on FIG. 23 (where another gripper 71 is shown in phantom outline). Gripper 71b can slide freely down handle 30, so that when released by the person it slides downwardly into gripper receptacle 32, there to be accumulated with other discarded grippers 71 in the same way as grippers 5 accumulate in receptacle 7. Receptacle 32 works in the same way as receptacle 7, having a guide rail 41 with the same cross-sectional shape as that of handle 30 but otherwise playing the same role as guide rail 20 of receptacle 7.

This embodiment has the difference from the one shown in FIGS. 16 to 21 that grippers 71 are not able to be removed from the door 37 altogether, as they are initially captive in dispenser 31, then captive on handle 30 and finally captive in receptacle 32.

This other embodiment can be further modified (not shown) so that the dispenser and receptacle guide rails are of the same cross-section, thus allowing for the dispenser and receptacle to be interchangeable as described above. Referring to FIG. 24, there is shown a view, comparable to FIGS. 18 and 22, of such an embodiment. A dispenser 90 is the same as dispenser 4, having a guide rail 91 for grippers 92 as described above. Directly below guide rail 91 is a handle 93 secured to a door 99, having a cross-section the same as guide rail 91. Below handle 93 is a gripper collection means 94 the same as collection means 7, and in particular having a guide rail 95 of the same cross-section as handle 93. The lowermost gripper 92a or grippers 92 in dispenser 90 is prevented from sliding down handle 93 by a stop 96 formed from a flexible resilient material such as rubber. Using a finger 97, a user can pull gripper 92a downwards onto handle 93 so as to move door 99. Thereafter, the user can simply let go of gripper 92a which slides down onto the guide rail 95 of collection means 94. As with the embodiments described above, a user can of course simply grip handle 93 directly if unwilling to use the gripper 92a.

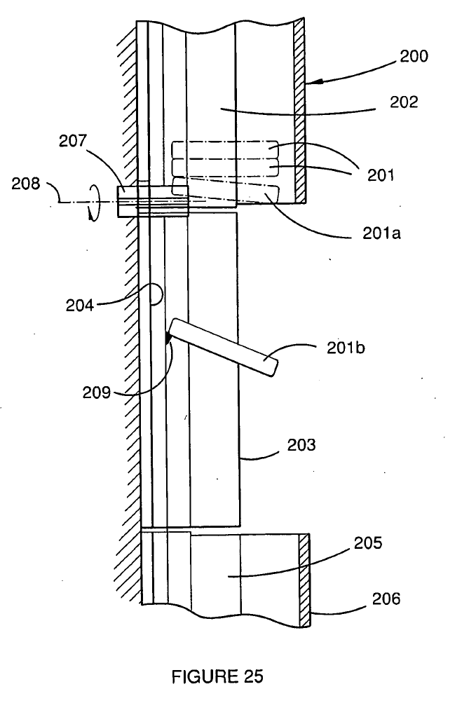

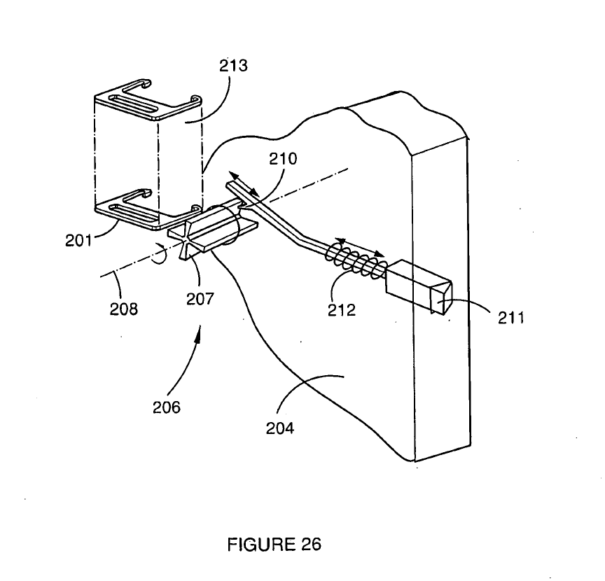

FIGS. 25 and 26 show yet another possible embodiment of the invention. FIG. 25 is comparable in viewpoint with FIGS. 18, 22 and 24, showing a dispenser 200 for grippers 201. Grippers 201 are the same as grippers 5, 71 and 102 and are held on a guide rail 202 comprised in dispenser 200. Handle 203 is secured to door 204, has the same cross-sectional shape as guide rail 202, and is directly below guide rail 202. Below handle 203 is guide rail 205 of a gripper collection means 206. Dispenser 200 and gripper collection means 206 are when seen in horizontal cross-section the same as dispenser 4 and collection means 7 respectively. Mounted within door 204 is a mechanism 206, shown in FIG. 26, but of which only a rotary member 207 is shown in FIG. 25. Rotary member 207 is able to rotate about a horizontal axis 208 in door 204 and is shaped so that when it executes a quarter turn, only the lowermost 201a one of grippers 201 is freed to slide down onto handle 203. It is then stopped partway down handle 203 (in the position shown as 201b) by a rubber (or similar) formation 209 that is adjusted so as to just stop further downward movement of gripper 201b, but so as not to prevent gripper 201b when released by its user from sliding down handle 203 onto guide rail 205.

The advantage of this embodiment is that one gripper in position 201b is presented to an intending user, in a convenient position, and all others are held covered within dispenser 200, and so unable to be contaminated. When this user has passed through the door 204 and released his gripper 201, another gripper 201 is automatically dispensed into position 201b, ready for the next user.

The mechanism 206 for dispensing one gripper 201 at a time from a stack 213 in dispenser 200 is shown schematically in FIG. 26. Rotary member 207 is turned through a quarter turn, so as to release just one gripper 201, by a pawl 210. Pawl 210 is moved when a latch 211 is moved horizontally inward into door 204 by hitting a striker plate (not shown) on the frame (not shown) of door 204. Latch 211 is biased outwards by a compression spring 212 in door 204. Thus when a user opens door 204 the latch 211 is in its extended-out position, but when door 204 hits its striker plate as door 264 is closed, a fresh gripper 201 is dispensed and falls into the position 201b (FIG. 25). Persons skilled in the art will recognize that there are many alternative ways to secure one-at-a-time release of grippers.

Turning now to the handling of used grippers, this may be done in any of several ways. One is to wash and re-use them. If the grippers are made of a recyclable material, for example by injection moulding in a suitable thermoplastics material, another option is to recycle them.

It will be understood that although only one gripper design has been shown and only one guide rail section and only two handle sections, a very wide range of gripper designs and guide rail/handle cross-sectional shapes may be used. In particular, it is possible for a gripper (not shown) to be used that has a portion adapted to sliding engage in a female slot in a handle or guide rail, as opposed to the arrangement shown in which grippers partially surround handles and guide rails on their exteriors.

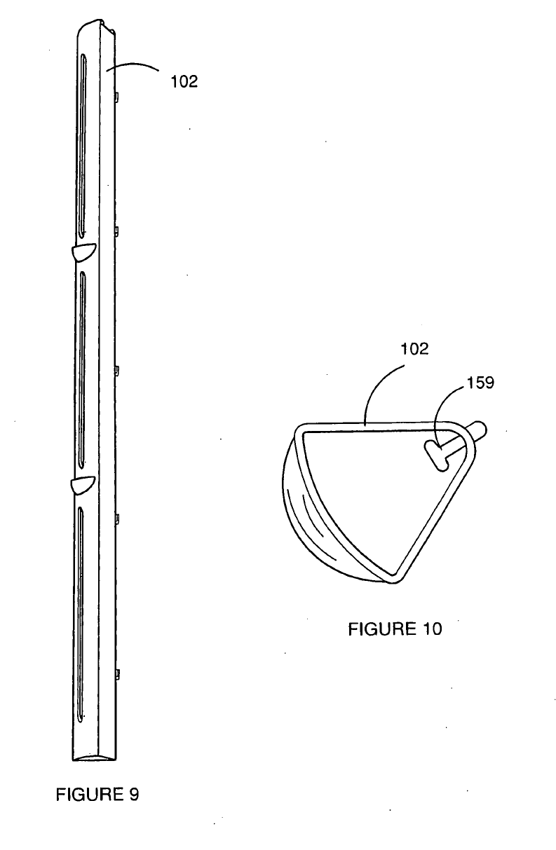

To enhance the usefulness of the invention still further, it is possible to provide suitable means for detecting that a person is approaching the door in question and operating a light source (e.g. a light emitting diode) on the opposite side of the door so as to warn persons on that (outer) side that the door is about to be opened from the inside. This could be done for example by any of the usual means for non-contact detection of people, such as radar, ultrasonic or infra-red detectors. Another possibility would be for the stop 106 of FIG. 9 to comprise an actuating part of a microswitch that operates the light source. Still another possibility, where the grippers supplied are designed to be carried away from the door (as in the system of FIGS. 16 to 21) the grippers could be provided with components the same as radio-frequency identification (RFID) tags so as to actuate a suitable detector at the door which in turn would operate the light source.

Grippers such as grippers 5 and 71 lend themselves well to having advertising or identifying information marked on them during production (e.g. by injection moulding). For example, the name of a hotel using the system as described could be embossed on member 22 of each gripper 5.

1: A hygienic door operating device comprising a dispensing means arranged to contain a plurality of gripping handles and adapted to dispense a separate handle to each person operating the door, the gripping handle being adapted to engage a formation secured to the door whereby the door can be operated by manual engagement of the gripping handle, and disposal means to transfer the gripping handle to a collection receptacle after use.

2: The device according to claim 1 wherein the dispensing means is adapted to contain a plurality of gripping handles and to dispense one at a time to the user from a dispensing position.

3: The device according to claim 2 wherein the dispensing means comprises means for storing said plurality of gripping handles so that when one gripping handle of the plurality of gripping handles is dispensed from the dispensing position another gripping handle of the plurality of gripping handles moves automatically into said dispensing position, until all gripping handles of the plurality of gripping handles have been dispensed.

4: The device according to claim 3 wherein the dispensing means comprises a cassette having an elongate guide for holding undispensed gripping handles in array therealong.

5: The device according claim 4 wherein the gripping handles may be held on and are slidable under gravity along said guide to said dispensing position at a bottom end of said cassette.

6: The device according to claim 1 wherein said dispensing means is removable from the device.

7: The device according to claim 1 wherein the gripping handle, when dispensed, is adapted for subsequent engagement by the user with a formation on the door.

8: The device according to claim 1 wherein the gripping handle, when dispensed by the dispensing means, is engaged with a formation on the door.

9: The device according to claim 8 wherein said formation on the door may comprise an elongate member on which said gripping handle is slideable up and down.

10: The device according to claim 9 wherein the formation is adapted to be gripped and used as a handle for the door in the event that no gripping handle is available or a user simply elects to grasp the handle directly.

11: The device according to claim 1 wherein the gripping handle has at least one retaining portion which is retained in and slideable on a slot in said formation once said gripping handle is engaged with the formation.

12: The device according to claim 1 wherein the collection receptacle is adapted and in use positioned on said door to receive gripping handles when let go by a user after use thereof to move the door.

13: The device according to claim 12 wherein said collection means comprises an internal space into which gripping handles engaged with said formation fall under gravity when released by users.

14: A method for provision of a hygienic door opening facility at a location, said method comprising the steps of:
providing at least said hygienic door operating device as claimed in claim 1;
attaching said device to the door;
providing at least one said gripping handle in said dispensing means; and
collecting and removing said at least one gripping handle from said location after use.

15: The method according to claim 14 including the step of cleaning the or each discarded gripping handle and reusing the same in the device.

16: The method according to claim 15 including the steps of recycling the discarded gripping handles and manufacturing new gripping handles from the material of such recycled gripping handles.

17: A hygienic door operating device adapted to be secured to a face of a door, the device comprising a dispenser adapted to dispense a separate gripping handle to a rotor, the rotor being adapted to locate and hold the gripping handle, the rotor being rotatable from a dispense position in which the gripping handle is located in the rotor within the device to an operative position in which a user can contact the gripping handle to move the door, to a disposal position in which the gripping handle drops from the rotor whereby movement of the rotor facilitates a fresh gripping handle being dispensed.

18: The device according to claim 17 wherein each gripping handle drops by gravity from the dispenser to be located and engaged by the rotor and then dropped by gravity from the rotor into a collection bin at the disposal position.

19: The device according to claim 17 wherein in the dispense position the gripping handle is located in a first plane and in the operative position the gripping handle drops to be supported by the rotor in a plane lower than the first plane.

20: The device according to claim 17 wherein the rotor defines three radially extending equally spaced gaps, each gap being adapted to locate and engage a gripping handle, and the device has two dispense positions on either side of the operative position.

21: The device according to claim 17 wherein columns of gripping handles are located in two spaced cassettes mounted above the path of the rotor.

22: The device according to claim 17 wherein the rotor is driven by an electric motor.

23: The device according to claim 22 wherein the motor is programmed to index the rotor through six equally spaced positions in one revolution in either direction.

24: The device according to claim 17 wherein the rotor rotates in one direction through 60° between the dispense position and the operative position and then rotates in the reverse direction back to the dispense position, and the gripping handle drops from the rotor as it reverses.

25: The device according to claim 17 wherein a proximity sensor is positioned at the front of the device to be activated by hand movement to cause rotation of the rotor.

26: The device according to claim 17 wherein a warning light is positioned on the opposite face of the door to illuminate when the proximity sensor is activated.

27: The device according to claim 17 wherein at least one sensor is positioned against the rotor to sense the presence of a gripping handle.

28: The device according to claim 17 wherein a locating sensor is positioned against the rotor to interact with the rotor to ensure exact angular alignment of the rotor.

29: The device according to claim 17 wherein a displaceable locking pin is positioned to engage and lock the rotor in the operative position.

30: The device according to claim 29 wherein the pin is disengageable from the rotor to effect rotation.
